(19) United States
(12) Patent Application Publication
(10) Pub. No.: US 2015/0066276 A1
(43) Pub. Date: Mar. 5, 2015

(54) INVERTED TWO-WHEEL APPARATUS

(71) Applicant: TOYOTA JIDOSHA KABUSHIKI KAISHA, Toyota-shi (JP)

(72) Inventors: Issei NAKASHIMA, Toyota-shi (JP); Masahiro Kamimura, Hiroshima-shi (JP)

(73) Assignee: TOYOTA JIDOSHA KABUSHIKI KAISHA, Toyota-shi (JP)

(21) Appl. No.: 14/471,204

(22) Filed: Aug. 28, 2014

(30) Foreign Application Priority Data
Aug. 28, 2013 (JP) 2013-176425

(51) Int. Cl. B60K 28/10; B60K 28/04; B62K 3/00

(52) U.S. Cl. CPC B60K 28/10; B62K 3/007; B60K 28/04; B60Y 2400/303
USPC 701/22

(57) ABSTRACT

An inverted two-wheel apparatus includes: a motor that drives wheels; an angular velocity control unit that generates a target angular velocity for controlling the angular velocity of the motor; an angular velocity detection unit that detects the detected angular velocity of the motor; and a stop control unit that inhibits the rotation of the motor if the difference between the target angular velocity and the detected angular velocity is equal to or larger than an angular velocity threshold.

### INCORPORATION BY REFERENCE

The disclosure of Japanese Patent Application No. 2013-176425 filed on Aug. 28, 2013 including the specification, drawings and abstract is incorporated herein by reference in its entirety.

### BACKGROUND OF THE INVENTION

1. Field of the Invention

The present invention relates to an inverted two-wheel apparatus.

2. Description of Related Art

An inverted two-wheel apparatus, which travels while maintaining the inverted state, is known.

For example, WO 2011/108029 discloses an inverted two-wheel apparatus that includes a motor that drives the wheels, a control unit that generates a torque command value for controlling a torque generated by the driving of a motor, and attitude detection means that detects attitude information on the inverted two-wheel apparatus.

Incidentally, a rider who is going to ride an inverted two-wheel apparatus sometimes tilts the apparatus too much to the rider side. This causes the inverted two-wheel apparatus, disclosed in WO 2011/108029, to travel toward the rider to maintain the inverted state. This traveling sometimes causes the inverted two-wheel apparatus to come in contact with, and keep on pushing, the foot of the rider.

### SUMMARY OF THE INVENTION

The present invention provides an inverted two-wheel apparatus that does not keep on pushing the foot of the rider even if the rider, who is going to ride the apparatus, tilts the apparatus too much to the rider side.

A first aspect of the present invention relates to an inverted two-wheel apparatus. An inverted two-wheel apparatus includes a motor that drives wheels; an angular velocity control unit that generates a target angular velocity for controlling an angular velocity of the motor; an angular velocity detection unit that detects a detected angular velocity of the motor; and a stop control unit that inhibits a rotation of the motor if a difference between the target angular velocity and the detected angular velocity is equal to or larger than an angular velocity threshold.

According to the aspect described above, the inverted two-wheel apparatus does not keep on pushing the foot of the rider even if the rider, who is going to ride the apparatus, tilts the apparatus too much to the rider side.

On the other hand, a second aspect of the present invention relates to an inverted two-wheel apparatus. An inverted two-wheel apparatus includes a motor that drives wheels; a torque sensor that detects a detected torque of the motor; and a stop control unit that differentiates the detected torque to calculate a detected torque derivative and, if the detected torque derivative is equal to or larger than a torque derivative threshold, inhibits a rotation of the motor.

According to the aspect described above, the inverted two-wheel apparatus does not keep on pushing the foot of the rider even if the rider, who is going to ride the apparatus, tilts the apparatus too much to the rider side.

The inverted two-wheel apparatus in the aspects described above does not keep on pushing the foot of the rider even if the rider, who is going to ride the apparatus, tilts the apparatus too much to the rider side.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view of an inverted two-wheel apparatus in a first embodiment of the present invention;

FIG. 2 is a configuration diagram of the inverted two-wheel apparatus in the first embodiment of the present invention;

FIG. 3 is a flowchart showing a control method in the first embodiment of the present invention;

FIGS. 4A to 4G are schematic diagrams showing the control method in the first embodiment of the present invention;

FIG. 5 is a graph showing angular velocity versus time;

FIG. 6 is a configuration diagram of an inverted two-wheel apparatus in a second embodiment of the present invention; and

FIG. 7 is a flowchart showing a control method in the second embodiment of the present invention.

### DETAILED DESCRIPTION OF EMBODIMENTS

### First Embodiment

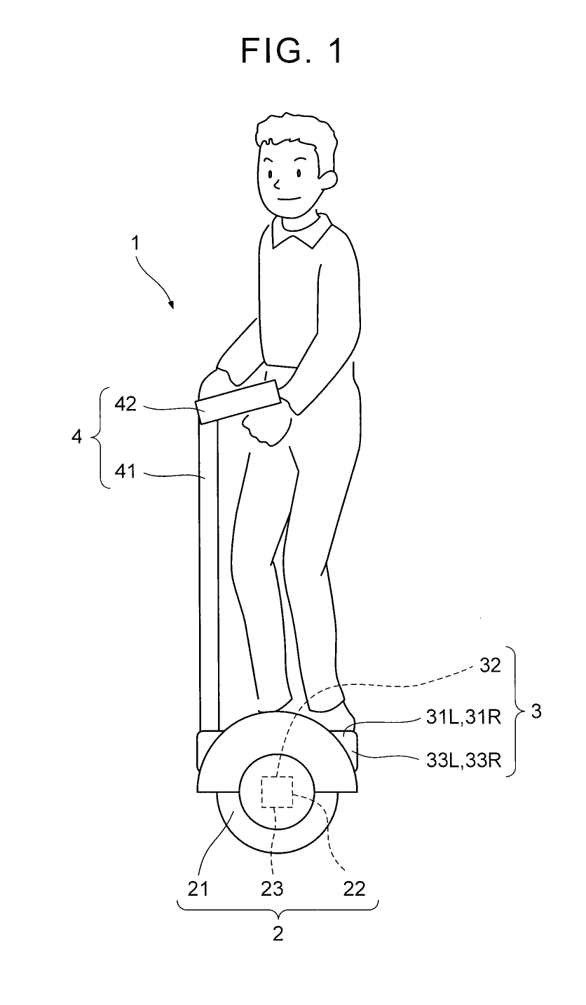

An inverted two-wheel apparatus in a first embodiment is described below with reference to FIG. 1. FIG. 1 is a side view of the inverted two-wheel apparatus in the first embodiment.

As shown in FIG. 1, an inverted two-wheel apparatus 1 includes a wheel unit 2, a platform unit 3, and a handle 4.

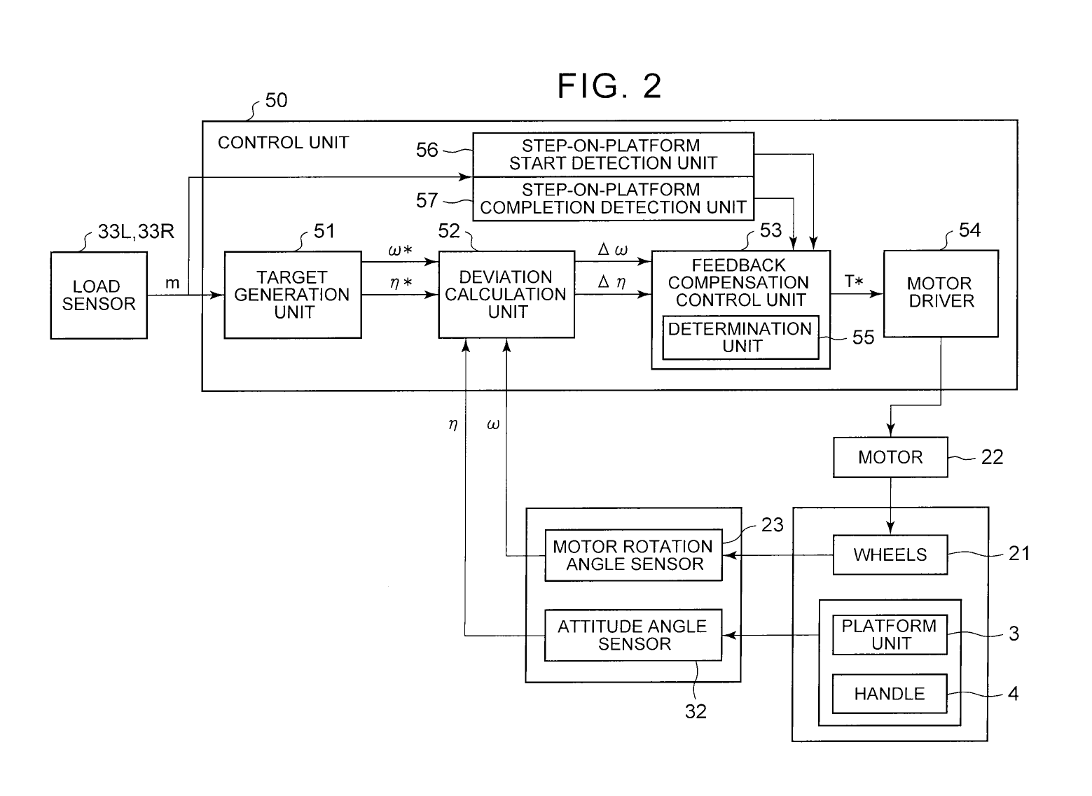

The wheel unit 2 includes wheels 21, a motor 22, and a motor rotation angle sensor 23. The motor 22 drives the wheels 21. The motor rotation angle sensor 23 can detect the angle of the wheels 21. The motor rotation angle sensor 23 is equipped, for example, with a resolver and an encoder. The motor rotation angle sensor 23 calculates the angular velocity ω by differentiating the detected angles (see FIG. 2) and outputs the signal about the angular velocity ω.

The platform unit 3 includes steps 31R and 31L, an attitude angle detection sensor 32, and load sensors 33L and 33R. The step 31R, provided above the wheel unit 2, is a support plate for supporting the right foot of a rider. The step 31L, provided above the wheel unit 2, is a support plate for supporting the left foot of the rider. The attitude angle detection sensor 32 is a sensor for detecting the attitude angle of the platform unit 3 and the handle 4. The attitude angle detection sensor 32 is a sensor such as a gyro sensor or an acceleration sensor. The attitude angle detection sensor 32 detects a detected attitude angle η (see FIG. 2) and outputs the signal about the detected attitude angle The load sensor 33L detects the load placed on the step 31L, and the load sensor 33R detects the load placed on the step 31R. The load sensors 33L and 33R can detect the center of gravity, pitch angle, and roll angle of the load placed on the steps 31L and 31R. The load sensors 33L and 33R generate the signal about the load information m (see FIG. 2). The load information m includes information about the magnitude and the center of gravity of the load placed on the steps 31L and 31R. The load information m may also include information such as the pitch angle and the roll angle of the steps 31L and 31R.

The handle 4 includes a shaft unit 41 that extends upward from the platform unit 3 and a hand grip unit 42 that is supported at the top end of the shaft unit 41. The hand grip unit 42 has a shape that can be gripped by both hands of a rider. The shape of the hand grip unit 42 may be changed so that a rider holds it with his or her feet. The length of the shaft unit 41 may be changed as necessary according to the change in the shape of the hand grip unit 42.

Next, the configuration of the inverted two-wheel apparatus is described with reference to FIG. 2. FIG. 2 is a configuration diagram of the inverted two-wheel apparatus in the first embodiment.

As shown in FIG. 2, a control unit 50 includes a target generation unit 51, a deviation calculation unit 52, a feedback compensation control unit 53, a motor driver 54, and a determination unit 55. In addition, the control unit 50 may include a step-on-platform start detection unit 56 that detects the start of rider's step-on-platform action and a step-on-platform completion detection unit 57 that detects the completion of rider's step-on-platform action. The control unit 50 is connected to a power supply, not shown, and electric current is supplied to the control unit 50 as necessary. The control unit 50 includes an operation circuit that has a central processing unit (CPU), and a storage device that has a program memory, a data memory, and other memories such as a random access memory (RAM) and a read-only memory (ROM).

The target generation unit 51 receives the signal about the load information m from the load sensors 33L and 33R. Based on the load information m, the target generation unit 51 calculates the target angular velocity ω* and the target attitude angle η* and outputs the signal about the target angular velocity ω* and the target attitude angle η*.

The deviation calculation unit 52 receives the signal about the target angular velocity ω* and the target attitude angle η* from the target generation unit 51. The deviation calculation unit 52 also receives the signal about the detected angular velocity ω from the motor rotation angle sensor 23, and the detected attitude angle η from the attitude angle detection sensor 32. The deviation calculation unit 52 calculates the difference between the target angular velocity ω* and the detected angular velocity w (deviation angular velocity Δω) and the difference between the target attitude angle η* and the detected attitude angle η (deviation attitude angle Δη) and outputs the signal about the deviation angular velocity Δω and the deviation attitude angle Δη.

The feedback compensation control unit 53 includes the determination unit 55. The determination unit 55 determines whether the deviation angular velocity Δω is equal to or higher than, or lower than, the angular velocity threshold Δω1. The angular velocity threshold Δω1 is stored in advance in the determination unit 55. The feedback compensation control unit 53 receives the signal about the deviation angular velocity Δω and the deviation attitude angle Δη. The feedback compensation control unit 53 outputs the signal about the target torque T*.

If the deviation angular velocity Δω is lower than the angular velocity threshold Δω1, the feedback compensation control unit 53 outputs the signal about the inverted control torque Tt* as the signal about the target torque T*. The inverted control torque Tt* is a torque value for allowing the inverted two-wheel apparatus 1 to travel based on the load information m while maintaining the inverted state. That is, the inverted control torque Tt* is a torque value for performing the inverted control.

On the other hand, if the deviation angular velocity Δω is equal to or higher than the angular velocity threshold Δω1, the feedback compensation control unit 53 outputs the signal about the stop torque Ts* as the signal about the target torque T*. The stop torque Ts* is a torque value for controlling the torque of the motor 22 such that the rotation of the wheels 21 is stopped. That is, the stop torque Ts* is a torque value for performing the stop control. The stop torque Ts* may be a torque value the direction and magnitude of which inhibits the inverted two-wheel apparatus 1 from traveling toward the rider side.

The motor driver 54 receives the signal about the target torque T* from the feedback compensation control unit 53. The motor driver 54 supplies electric current to the motor 22 based on the signal about the target torque T*.

The motor 22 receives electric current from the motor driver 54 to drive the wheels 21. The motor rotation angle sensor 23 detects the angle of the wheels 21, calculates the detected angular velocity ω, and outputs the signal about the detected angular velocity ω to the deviation calculation unit 52. The attitude angle detection sensor 32 detects the detected attitude angle η and outputs the signal about the detected attitude angle η to the deviation calculation unit 52.

### Control Method

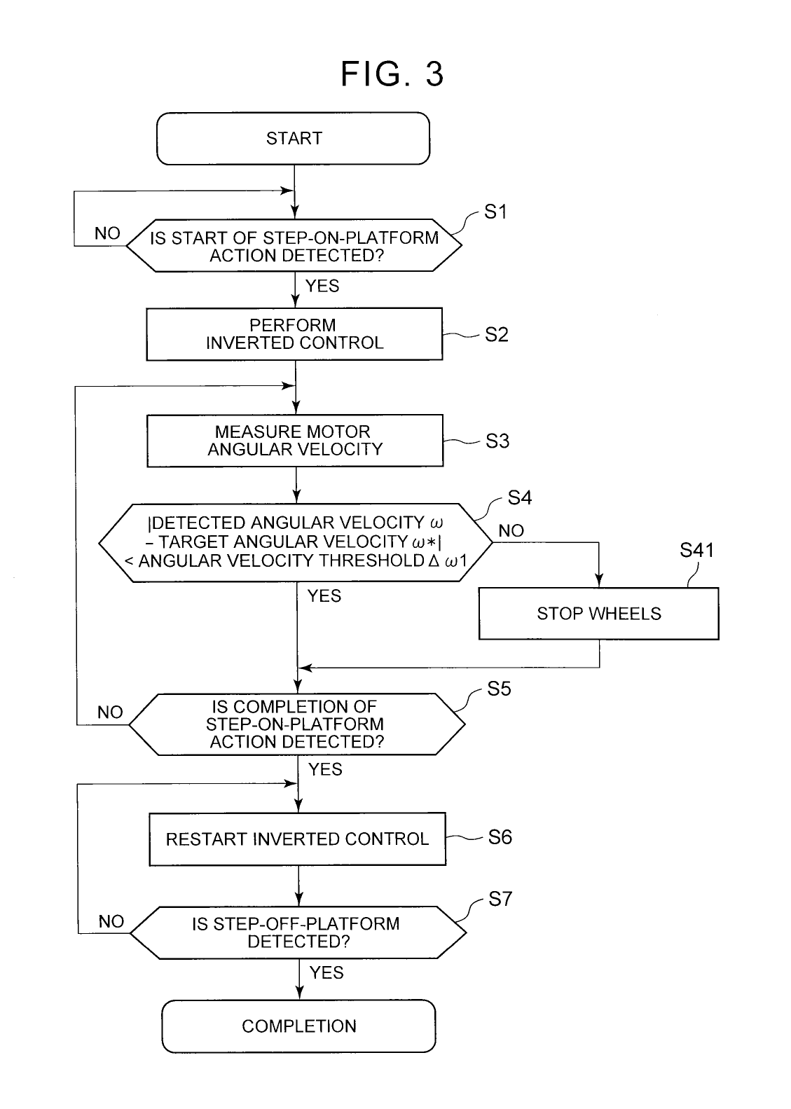

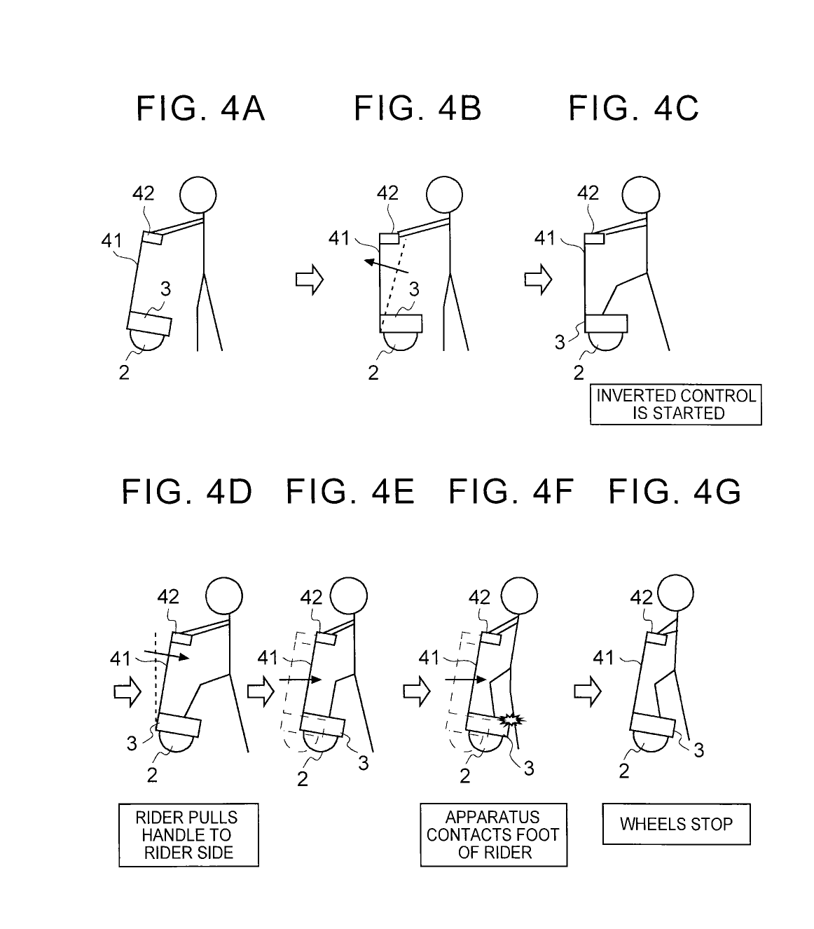

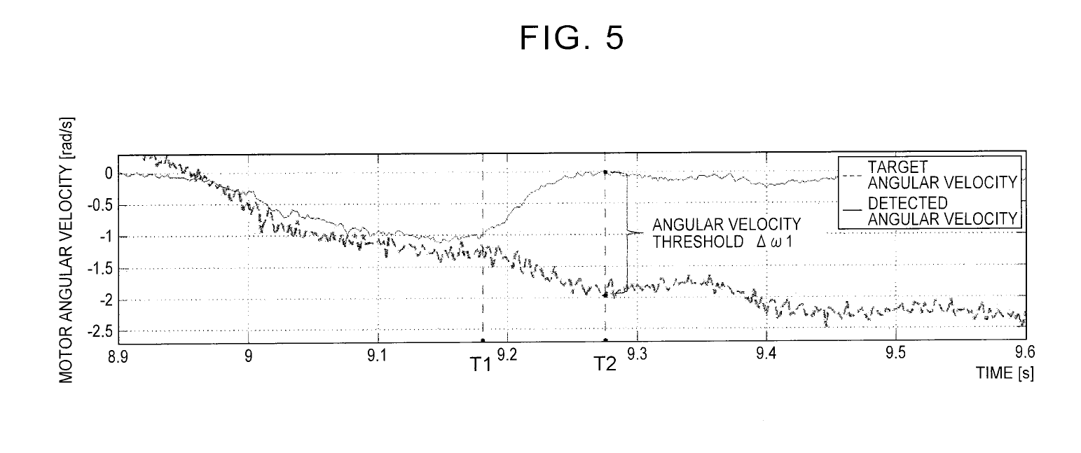

Next, with reference to FIGS. 3 to 5, the control method for controlling the inverted two-wheel apparatus in the first embodiment is described. FIG. 3 is a flowchart showing the control method in the first embodiment. FIG. 4A to 4G are schematic diagrams showing the control method in the first embodiment. FIG. 5 is a graph showing angular velocity versus time.

As shown in FIGS. 4A to 4C, the start of the step-on-platform action is detected (step-on-platform start detection step S1). More particularly, as shown in FIG. 4A, a rider holds the hand grip unit 42 with both hands. Next, as shown in FIG. 4B, the rider changes the attitude angle of the inverted two-wheel apparatus 1 so that the rider can easily place one foot on one of the steps 31L and 31R. For example, the rider changes the attitude angle of the inverted two-wheel apparatus 1 so that the longitudinal direction of the shaft unit 41 stays approximately upright. Next, as shown in FIG. 4C, one of the steps 31L and 31R supports one foot of the rider and detects the load (step-on-platform start detection step S1: YES). Note that the step-on-platform start detection step S1 of this control method may be executed by the step-on-platform start detection unit 56. More specifically, based on the load information indicating that the load is placed on only one of the steps 31L and 31R, the step-on-platform start detection unit 56 may determine that the rider has started the step-on-platform action.

Next, the inverted control is started (inverted control step S2). In addition, the motor rotation angle sensor 23 measures the detected angular velocity w (motor angular velocity measurement step S3), calculates the difference between the detected angular velocity ω and the target angular velocity ω*, and confirms whether the deviation angular velocity Δω is higher than the angular velocity threshold Δω1 (deviation angular velocity confirmation step S4).

Next, as shown in FIG. 4D, when the rider pulls the handle 4 towards the rider side, the inverted two-wheel apparatus 1 tilts to the rider side.

Next, as shown in FIG. 4E, the inverted control works to cause the inverted two-wheel apparatus 1 to travel while maintaining the inverted state. More specifically, the inverted two-wheel apparatus 1 travels towards the rider side in order to maintain the inverted state.

Next, as shown in FIG. 4F, the inverted two-wheel apparatus 1 comes in contact with the foot of the rider, decreasing the travel speed of the inverted two-wheel apparatus 1. This causes the detected angular velocity ω to deviate largely from the target angular velocity ω* from time T1 to time T2, as shown in FIG. 5. That is, the deviation angular velocity Δω increases. When the time reaches time T2, the deviation angular velocity Δω becomes equal to or higher than the angular velocity threshold Δω1 (deviation angular velocity confirmation step S4: NO). Then, the inverted control is once stopped and the stop control is started in order to stop the wheels 21 (wheel stop step S41). As a result, the inverted two-wheel apparatus 1 does not travel towards the rider side but stops while staying in contact with the foot of the rider, as shown in FIG. 4G.

Next, when both load sensors 33L and 33R detect the load, the completion of the step-on-platform action is detected (step-on-platform completion detection step S5). The steps, from the motor angular velocity measurement step S3 to the deviation angular velocity confirmation step S4 or to the wheel stop step S41, are repeated until the completion of step-on-platform is detected. More particularly, when the completion of the step-on-platform action is detected, the inverted control is restarted (inverted control restart step S6). Note that the step-on-platform completion detection step S5 of this control method may also be executed by the step-on-platform completion detection unit 57. More specifically, based on the load information indicating that the load is placed on both the step 31L and the 31R, the step-on-platform completion detection unit 57 may determine that the rider has completed the step-on-platform action. In addition, at least the deviation angular velocity confirmation step S4 may be performed by the feedback compensation control unit 53. In this case, the feedback compensation control unit 53 may be executed from the time the start of the rider's step-on-platform action is detected to the time the completion of the rider's step-on-platform action is detected.

Finally, when it is detected that the rider has stepped off the platform (step-off-platform detection step S7), the control of the inverted two-wheel apparatus 1 is completed. More particularly, it is determined that the rider has stepped off the platform, for example, when the load on the load sensors 33L and 33R becomes smaller than a predetermined value or the load is not detected.

As described above, the inverted control can be performed in the first embodiment to allow the inverted two-wheel apparatus 1 to travel while maintaining the inverted state. The stop control can also be performed in the first embodiment based on the magnitude of the deviation angular velocity Δω to inhibit the inverted two-wheel apparatus 1 from keeping on pushing the foot of the rider when the rider steps on the platform. In addition, the load sensors 33L and 33R can detect the start and the completion of the rider's step-on-platform action, suitably performing the stop control of the inverted two-wheel apparatus 1.

### Second Embodiment

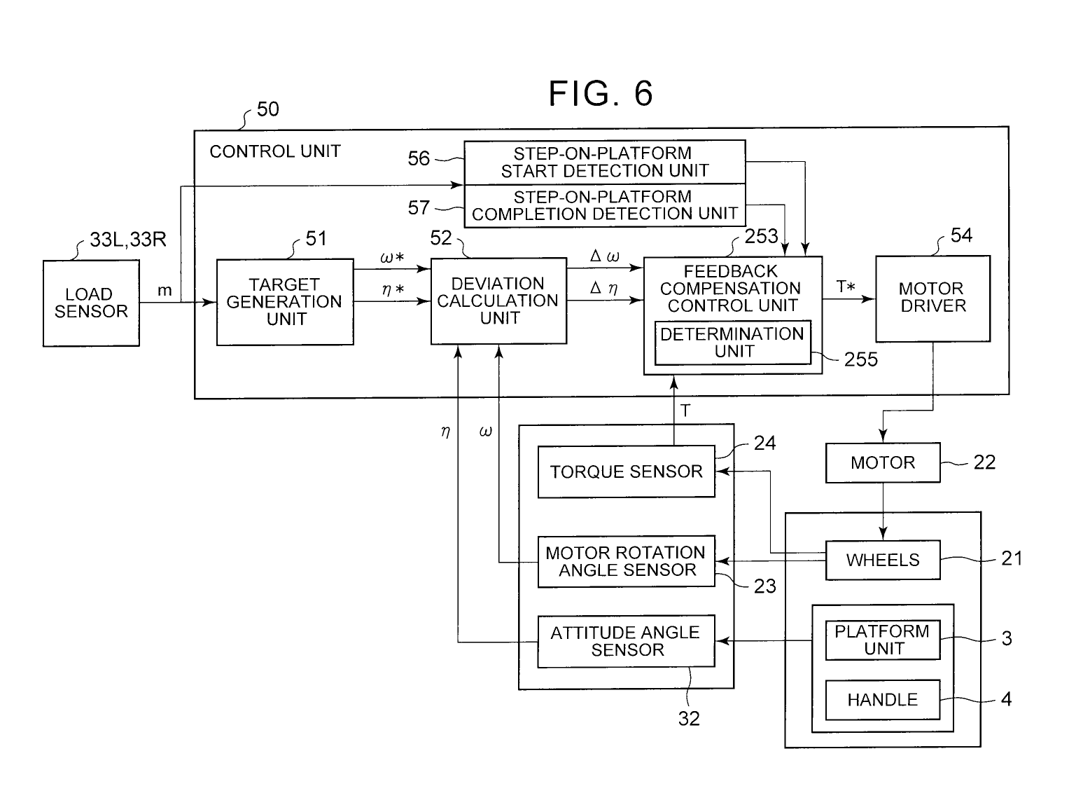

Next, an inverted two-wheel apparatus in a second embodiment is described with reference to FIG. 6. The inverted two-wheel apparatus in the second embodiment is similar to the inverted two-wheel apparatus in the first embodiment except that a torque sensor is provided. The other components of the configuration are the same as those of the configuration in the first embodiment and therefore the same reference numbers are used for the corresponding components.

As shown in FIG. 6, an inverted two-wheel apparatus 201 includes a torque sensor 24. The torque sensor 24 detects the detected torque T of the wheels 21. The torque sensor 24 may calculate the detected torque T from the electric current supplied to the motor 22. The torque sensor 24 outputs the detected torque T to a feedback compensation control unit 253.

The feedback compensation control unit 253 includes a determination unit 255. The determination unit 255 calculates the torque derivative DT by differentiating the detected torque T. In addition, the determination unit 255 determines whether the calculated torque derivative DT is equal to or higher than the torque derivative threshold DT1. The torque derivative threshold DT1 is stored in advance in the determination unit 255. The feedback compensation control unit 253 receives the signals about the deviation angular velocity Δω and the deviation attitude angle Δη. The feedback compensation control unit 253 outputs the signal about the target torque T*.

If the torque derivative DT is lower than the torque derivative threshold DT1, the feedback compensation control unit 253 outputs the inverted control torque Tt* as the target torque T*. The inverted control torque Tt* is a torque value for allowing the inverted two-wheel apparatus 1 to travel based on the load information m while maintaining the inverted state.

On the other hand, if the torque derivative DT is equal to or higher than the torque derivative threshold DT1, the feedback compensation control unit 253 outputs the stop torque Ts* as the target torque T*.

### Second Control Method

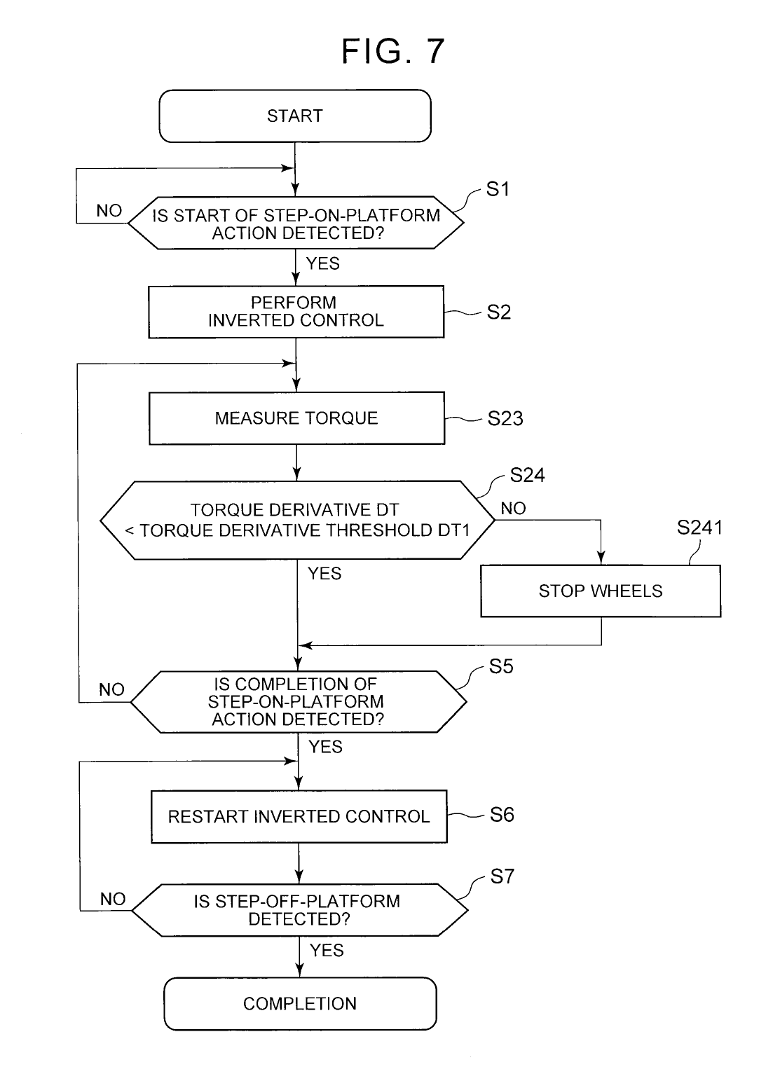

Next, the second control method in the second embodiment is described with reference to FIG. 4, FIG. 5, and FIG. 7. For the same steps as those in the control method in the first embodiment (see FIG. 3), the same reference numerals are used.

As in the control method in the first embodiment described above, the step-on-platform action start detection step S1 and the inverted control step S2 are performed. After that, the motor rotation angle sensor 23 measures the detected torque T (torque measurement step S3), and the determination unit 255 calculates the detected torque derivative DT from the detected torque T and confirms whether the detected torque derivative DT is higher than the torque derivative threshold (detected torque derivative confirmation step S4).

Next, as shown in FIG. 4D, when the rider pulls the handle 4 towards the rider side, the inverted two-wheel apparatus 201 tilts to the rider side.

Next, as shown in FIG. 4E, the inverted control works to cause the inverted two-wheel apparatus 201 to travel towards the rider side while maintaining the inverted state.

Next, as shown in FIG. 4F, the inverted two-wheel apparatus 201 comes in contact with the foot of the rider, decreasing the travel speed of the inverted two-wheel apparatus 201. This causes the detected angular velocity ω to deviate largely from the target angular velocity ω* as shown in FIG. 5. That is, the deviation angular velocity Aw increases. When the deviation angular velocity Aw increases, the feedback compensation control unit 253 outputs a large torque value to the motor driver 54 as the target torque T* (inverted control torque Tt*) in order to travel while maintaining the inverted state. The detected torque T increases significantly with the result that the detected torque derivative DT exceeds the threshold DT1 (detected torque derivative confirmation step S24: NO). Then, the inverted control is once stopped and the signal about the stop torque Ts* is output to stop the wheels 21 (wheel stop step S241). As a result, the inverted two-wheel apparatus 201 does not travel towards the rider side but stops while staying in contact with the foot of the rider, as shown in FIG. 4G.

After that, as in the control method in the first embodiment, the step-on-platform completion detection step S5 to the step-off-platform detection step S7 are performed and the control of the inverted two-wheel apparatus 201 is completed. At least the deviation angular velocity confirmation step S24 may be performed by the feedback compensation control unit 253. In this case, the feedback compensation control unit 253 may be executed from the time the start of the rider's step-on-platform action is detected to the time the completion of rider's step-on-platform action is detected.

According to the second embodiment, the inverted control can be performed to allow the inverted two-wheel apparatus 201 to travel while maintaining the inverted state. The stop control can also be performed based on the detected torque derivative DT to inhibit the inverted two-wheel apparatus 201 from keeping on pushing the foot of the rider when the rider steps on the platform.

What is claimed is:

1. An inverted two-wheel apparatus comprising:
a motor that drives wheels;
an angular velocity control unit that generates a target angular velocity for controlling an angular velocity of the motor;
an angular velocity detection unit that detects a detected angular velocity of the motor; and
a stop control unit that inhibits a rotation of the motor if a difference between the target angular velocity and the detected angular velocity is equal to or larger than an angular velocity threshold.

2. The inverted two-wheel apparatus according to claim 1 further comprising:
a step-on-platform start detection unit that detects a start of a rider's step-on-platform action; and
a step-on-platform completion detection unit that detects a completion of the rider's step-on-platform action,
wherein the stop control unit is executed from a time the start of the rider's step-on-platform action is detected to a time the completion of the rider's step-on-platform action is detected.

3. The inverted two-wheel apparatus according to claim 2 further comprising:
a first step that supports one foot of the rider;
a second step that supports another foot of the rider; and
a load sensor that detects load information,
wherein the step-on-platform start detection unit determines the start of the rider's step-on-platform action based on load information indicating that a load is placed on only one of the first step and the second step and
the step-on-platform completion detection unit determines the completion of the rider's step-on-platform action based on load information indicating that a load is placed on both the first step and the second step.

4. An inverted two-wheel apparatus comprising:
a motor that drives wheels;
a torque sensor that detects a detected torque of the motor; and
a stop control unit that differentiates the detected torque to calculate a detected torque derivative and, if the detected torque derivative is equal to or larger than a torque derivative threshold, inhibits a rotation of the motor.

5. The inverted two-wheel apparatus according to claim 4 further comprising:
a step-on-platform start detection unit that detects a start of a rider's step-on-platform action; and
a step-on-platform completion detection unit that detects a completion of the rider's step-on-platform action,
wherein the stop control unit is executed from a time the start of the rider's step-on-platform action is detected to a time the completion of the rider's step-on-platform action is detected.

6. The inverted two-wheel apparatus according to claim 5 further comprising:
a first step that supports one foot of the rider;
a second step that supports another foot of the rider; and
a load sensor that detects load information,
wherein the step-on-platform start detection unit determines the start of the rider's step-on-platform action based on load information indicating that a load is placed on only one of the first step and the second step and
the step-on-platform completion detection unit determines the completion of the rider's step-on-platform action based on load information indicating that a load is placed on both the first step and the second step.
